(19) United States
(12) Patent Application Publication
(10) Pub. No.: US 2006/0156904 A1
(43) Pub. Date: Jul. 20, 2006

(54) Cubichord

(76) Inventor: David E. Gabert, Pocatello, ID (US)

Correspondence Address: SHANE A. KENNEDY, P.O. BOX 6408, BOISE, ID, 83707, US

(21) Appl. No.: 11/266,613

(22) Filed: Nov. 3, 2005

Related U.S. Application Data
(60) Provisional application No. 60/626,093, filed on Nov. 8, 2004.

(51) Int. Cl. G09B 15/02

(52) U.S. Cl. 84/483.2

(57) ABSTRACT

First, it is central to point out that the rules of traditional Music Theory from Pythagoras' monochord to theories of harmony from Ricardo Goldman, Walter Piston, and Arnold Schoenberg have been researched and applied to the development of the Cubichord System™, and that Cubichord believes this System does not in any way contradict nor superseede those explanations of Music Theory and Harmony.³⁰
³⁰ Australian Michael Furstner at jazclass, on the internet, introduced me to Music in 2000.
Furthermore, the principles of mathematics and logic specifically apply, especially the basic axiom that if A=B, and B=C, then A=C. That is, if an event or chord is presented in one color it logically applies for another and works the same, using the traditional major chord tones. This is true because of the perfect symmetry of the Cubichord™ system, and has thus far proved true and correct for any chord or interval applied within the system or as commonly used in music.

For this reason when I demonstrate that a chord in one color the principles continue to similarly apply in each of the three basic colors used, white, black, and blue, and also with different color choices, silver, black and gold, or whatever selection of three colors you choose; likewise, it will always be.³¹
³¹ Note: in my two models so far I have kept the Co7's white or silver, and the Eo7th's Black, only changing the color slightly with silver, and retaining ½ of the original colors, as white for C & A, and as black for Bb and Db; these would change if one were to begin with other colors, but clearly from my research, not vary from the perfect principles of Cubichord™.
However, it should be kept in mind that Cubichord™ is not a governmental nor privately owned or sponsored endeavor, but just the lone efforts of an erstwhile lawyer and neo-musician to simplify the understanding, playing, and performance of Music. For these reasons Cubichord™ posits this invention humbly and with nothing but good intentions and for the better understanding and simplification of Music, and in no way intends to disparage nor be overly critical of current Music, Classical, Jazz, Rock, Blues or whatever type, or with formal Musical study and formal pedagogy; however, Cubichord™ does believe there is great merit and benefit to be gained from this system, and it is for this reason alone that Cubichord™ posits this theory and invention, to simplify and to illustrate what can easily be so very complicated. Cubichord™ also apologizes for any errors or mistaken representations in the field of Music, as there has yet been insufficient time to edit and proof this application as will certainly be done by musicians examining this idea, and remains committed to historically and currently accurate Western Music Theory. This system is meant just to augment or parallel current music concepts, as it should not displace nor diminish any of the commonly held notions of Music Theory or Musicology, but should enhance them.

### CROSS-REFERENCE TO RELATED APPLICATIONS

Provisional Patent Application with $80.00 fee filed and received on Nov. 8, 2004 for application Ser. No. 60/626,093, for Cubichord; Licensed and dba for David E. Gabert, in Idaho, with Idaho Trademarks for Musical Instrument and Education/Instructional authorization.¹
¹ A Trademark registration has been granted in Cubichord™ for both instruments and for educational services by the Idaho Secretary of State, and is to be filed for Federal Registration soon.

### AUTHORIZATION FOR FOREIGN FILING

Country Code and number or priority application, to be used for filing abroad under the Paris Convention is U.S. Ser. No. 60/626,093, [if required Foreign filing license granted: Dec. 6, 2004] for “Cubichord”™, a visual chord and interval recognition system for Piano, keyboards, guitars (Cubitar™), as well as most other musical instruments, with application also to a musical notation system.

### FEDERALLY SPONSORED RESEARCH

None

### SEQUENCE LISTING OR PROGRAM

None

### BACKGROUND OF THE INVENTION

### FIELD OF INVENTION

This invention relates to the study, playing, teaching and Theory of Music and of Musical Instruments, specifically to a unique, new, mostly visual, chord and interval measuring and recognition system for pianos, keyboards, guitars, violins, and most, if not all chromatic or non-chromatic musical instruments. This is a utility invention resting upon the unique pattern or design structure of the natural occurring, three discrete sets of diminished chords have within the chromatic scale. Of course, this application is not an attempt to patent the “diminished” chords themselves, but to patent a system that visually illustrates them upon instruments or that displays or uses them in the education of music practice and theory, as well as in musical notation, which I call Cubichord™.

When each set of four notes is colored one of three colors, and then when this pattern is repeated upon the instrument and then over the entire chromatic, available scale, Cubichord™ is produced. These similarities of color are a constant and will not change with changes in any of the three colors. A three toned or colored keyboard or fret-board, in time and proof, should make much more musical sense than the two-tones black and white or the monotones currently coloring musical instruments, if at all colored. The Cubichord™ three color scheme instantly reveals to the trained eye the location of all traditional major, minor or other chord tones from the perspective of a given tonic in all 12 keys simultaneously, and identifies patterns for the simple shifting of tonal center or selection of proper or improvised note, depending on which category of Tonic, Chord Tone, or Off Tone color applies. A demonstration upon a model is the most illustrative example of how easy it then becomes to play most songs, but can also be explained herein and should be understood by the average trained musician when viewing these patterns on any instrument, as the drawings omit the best sense here, the ears, from consideration of the merits of this idea for locating tone.

### BACKGROUND OF THE INVENTION

Currently musicians must struggle an average of seven to ten years learning to play musical instruments. One problem inhibiting the understanding of instruments and music theory is that instruments display or sequence the entire set of notes for either the full twelve (12) note chromatic scale,² or a selected seven note major scale in a somewhat cryptic manner; as nothing theoretical or beneficial results from the traditional black and white piano keys but to better see the raised black sharps or flats or to represent the notes for just the key of C, but not for all keys simultaneously.³
² The entire set of notes most commonly used in the Western Musical World.

³ Just showing the key of C as all white is to the detriment of all eleven other keys.

For example, it has come to my attention that historically the black keys on the piano were up until the mid nineteenth century white, and the white keys then black. But given the shortness, different shape and elevated status of the upper level keys, it is clear they could be any color and still be readily visible to the player, even if all white. This has repeatedly proven true on the Cubichord™. The color scheme simply visually illustrates aspects of general music theory, as it reflects the structure of simple chord progressions, complex intervals, cadences and more.

The previous somewhat random distribution of white and black notes, especially on the piano, certainly assists in showing the C major scale as all the traditionally white notes and the black keys the chromatic alterations and deviations above, below, and between. Thus, reliance on color has always been taught in music from the first lesson, but ironically has then made learning to play music in the other keys and notes more difficult and unmanageable than is absolutely necessary, as, there is little, if anything left of the black and white color scheme to assist one with the other eleven major scales in the manner of Cubichord, or that is, until the Cubichord color scheme is applied to your instrument.

When you compare a keyboard with the Cubichord™ system, which instantly reveals to the trained eye the major chord tones for all keys as a basis for location and reference, through the location of the diminished chords, it's like the meaning of the keyboard or piano is staring back at the musician in the forms and structures, natural to music, but as first illustrated by the Cubichord system.⁴ Cubichord has shown me that it makes more sense to have the keys colored to match the basic building blocks of fundamental Music Theory, than not.⁵ Cubichord™ has noticed no problem recognizing the raised, shorter keys now commonly colored white under the modified, re-colored, Cubichord™ system, and on learning certain exercises previously difficult or impossible with the current learning level, often can then perform them in the dark.
⁴ I call this path “The Walk Through the Black Forest”.

⁵ Note: the study of music theory is an essential part of any correctly designed instructional program; for example, the study of music theory is required by all NASM universities and colleges in the United States, and Cubichord merely an augmentation not intending to diminish these formal studies.

Without Cubichord, the daunting learning and performance problem in Music has been historically approached in an ad hoc fashion with little or no regard for generally accepted Music Theory. Most initiates commonly just play in the C, F & G, or in G, D & C.⁶ A lot of drudge practice historically required shifting visual focus between the musical notations on the sheet music to the instrument before showing where the musician should play, back and forth to the keyboard. Concentration is thus easily distracted. But, like the way to Carnegie Hall, rote practice, practice, and more practice has been the general prescription.
⁶ Since F incorporates Bb/A#, and G incorporates Gb/F3, with D bringing in the additional C#/Db, most people don't realize they've used all but two the 12 chromatic keys [omitting only Ab and Eb], there remains in many of my musician friends a comfort zone they let bar them from playing around in all keys.

Wouldn't it be marvelous, a friend once asked me, if you could see where to play correctly from right directly on the piano? Especially for all twelve of the notes and keys? That happened to me three days after I invented the Cubichord™ system, and the person was instantly taken with this idea. Cubichord has had good responses from its preliminary field tests, limited though they are at present.

But traditionally, because of the tedious, daily drudge, with very little progress for at least a year for most beginners, there continues to be only a small portion of our population that endures the tortures of rote practice and that eventually learns to play a musical instrument. Many musicians just give up, even after a decade of learning, not realizing how simple it really is to play an instrument. Music still remains a mystery to most people. Most avoid this Black Forest like the black plague, never realizing the joys Beethoven celebrates in his Classical favorite “The Ode to Joy”, except on the rare occasion when others play it, or through recorded music.

From Bach and Mozart to Armstrong and the Beatles, musicians have been but a select few and favored few among us. Realizing the innate reluctance of people, educators, and pedagogy to change, the Cubichord™ system will nevertheless endeavor to change some of this obscurity currently innate in musical instruments, and to firm up our reference locations on this slippery slope. This is accomplished mainly because in most sections and phrases, with a few rare exceptions, a musician will be playing in two colors at any given phrase or time, under the Cubichord system; the transitions from the Tonic colored tones, to the Chord colored tones is the most natural, and the use of the “Off” tone color with the chord tones or even with the tonics, are basically all the possible combinations. Simple as one, two, three, and it is really very surprisingly simple to play most little melodies, as they are just using either the chord tones with the tonic, for traditional major/minor shifts, or the off tones with the “fifth” chord tone, as they are the chord tones for the tonic, with a harmonic minor, Major 7^{th}, or suspended feeling. These three sets of colors, then, provide a more manageable cognitive process for the steps and shifts of tones, and provide this with full access to traditional harmonic compulsions and justifications, and can be accessed in any I, V, I or I, IV, I, V, I, or other harmonic cadences, thus providing access to all the chromatic notes in Western music through simply two chords. Inject things like tri-tone substitutions, done easily with each color, and the basis for improvisation is just pure sound and sight, tone and color with the added ease of Cubichord.

### BACKGROUND OF INVENTION

### OBJECTS AND ADVANTAGES

What the Cubichord™ system does is provide a simple, visually recognizable system for organizing the mystique of music into the familiar sounds we love and desire to hear. Since these sounds and harmonies are usually constructed of chords or chord tones, the Cubichord™ system presents a permanent, simple, visual display which separates the currently randomly mixed notes into three sets of easily recognizable categories; and it does it with the novel application of just three (3) colors.⁷ While my current research has shown there exist efforts to colorize the chord tones, these colorizations usually consist of a dozen varieties of many single sets of colored dots for two or three of the chord tones; these preparations or early uses of color to denote ideas have been ad hoc and random, and do not resemble nor comprise a permanent system such as Cubichord that is permanent, and that always works the same way, in all keys.
⁷ An easy transfer of the system into Brail should also work to augment playing for the blind, not yet tested.

For colors, while any three will work, I have chosen and am now familiar and intimate with the two historical colors of the piano and keyboard, black and white, and have chosen blue to accompany the two traditional colors.⁸ It is the unique use of these three colors, spread over an octave, and continually repeated up the instrument scale, that guides the user to his note selections within the Cubichord system. This system could be applied for quick removal with a Cubichord kit, could be permanently applied with this kit, or could, with a license from Cubichord™, be applied from the manufacturer of most any instrument.
⁸ The Blues has been a primary incentive for this choice; but now Cubichord™ has designed a Silver, Black and Gold system, and it works identically. And now, since drafting this in 2004, 1 have a new set of colors on my Cubichord and Cubitar [the name I've chosen for the application on a guitar is Cubitar].

Cubichord

Because there are but three dichotomous and mutually exclusive categories of diminished chords, Cubichord resulted naturally, but has rarely, if ever, been so accurately and visibly represented. Each of these sets of chords works to locate, isolate and to select major and minor and other chords, and is at the foundation and basis of most Harmony in Western Music. Furthermore, because the diminished chords are uniquely constructed of a set of four notes of minor thirds throughout the musical system, and as each chord note in the diminished sequence is the fourth note in sequence, or three semitones apart, [three in between semitone intervals] the octave can be evenly divided and these divisions represented with three colors. 12/4=3 or 12/3=4. These three colors combine to show novice and expert alike visibly where these important and foundational chord structures are on a piano, keyboard, violin, guitar and/or most, if not all other musical instruments, and is contemplated for use in music publication, using the same idea.⁹
⁹There has been inadequate time and research to check this out empirically, but logic tells me what's good for the goose is good for the gander, and I've enjoyed great success from the keyboard to the Guitar, or Cubitar.

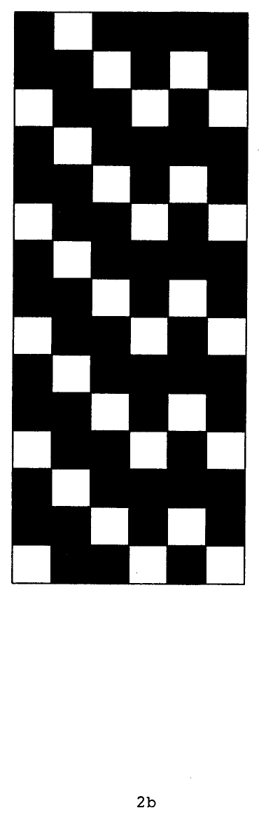

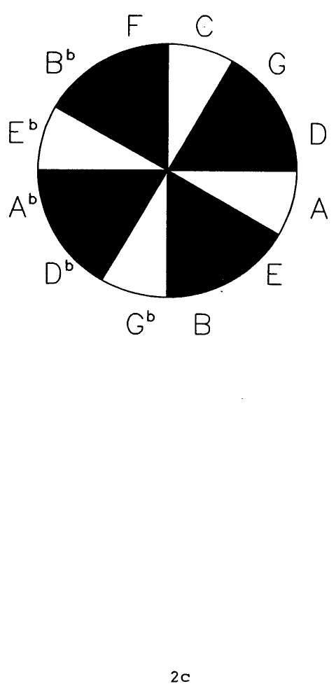

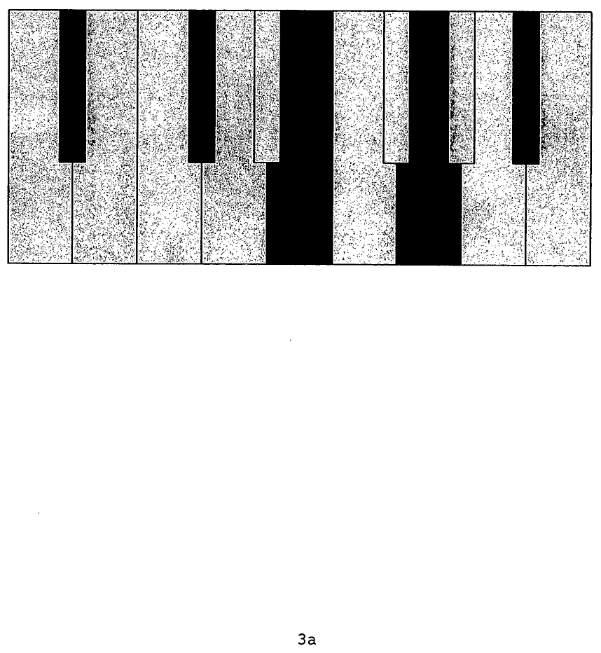

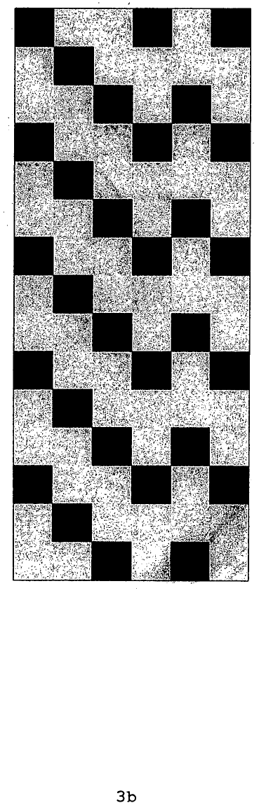

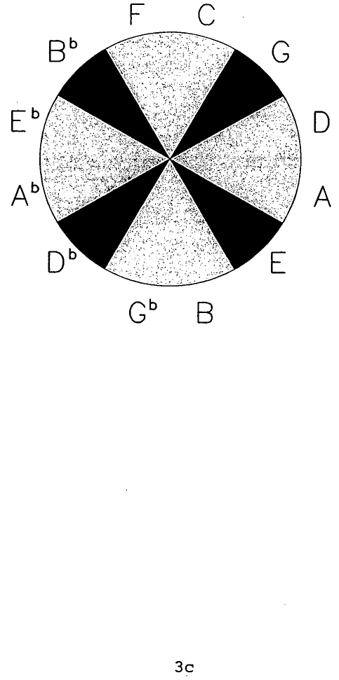

Most importantly the unique distribution of three colors shows a distinct and unique pattern, which never changes, despite color change or variability. Cubichord™ is very excited about this discovery, especially the potential for the application of the three colors to all musical instruments. The patterns revealed by Cubichord™ and Cubitar promise easy use and learning of the essential building blocks of music. The patterns are most revealing on Cubitar, the Guitar version of Cubichord, the revised and uniquely colored Piano and Keyboard. See especially FIGS. 2b and 3b, the guitar charts.

Three Colors

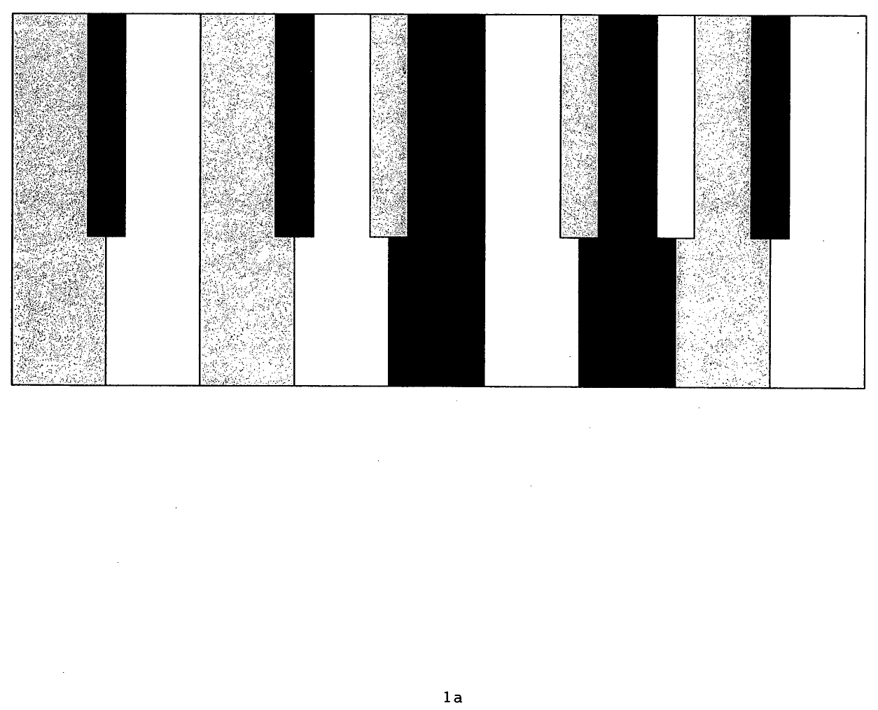

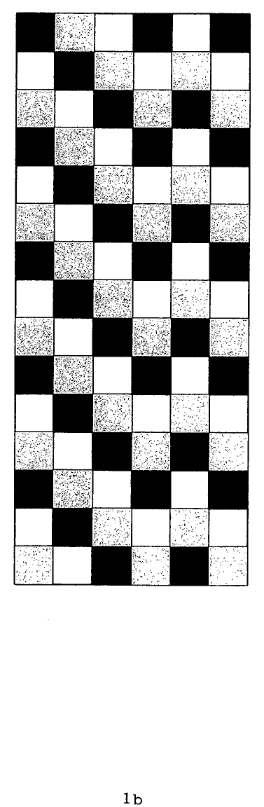

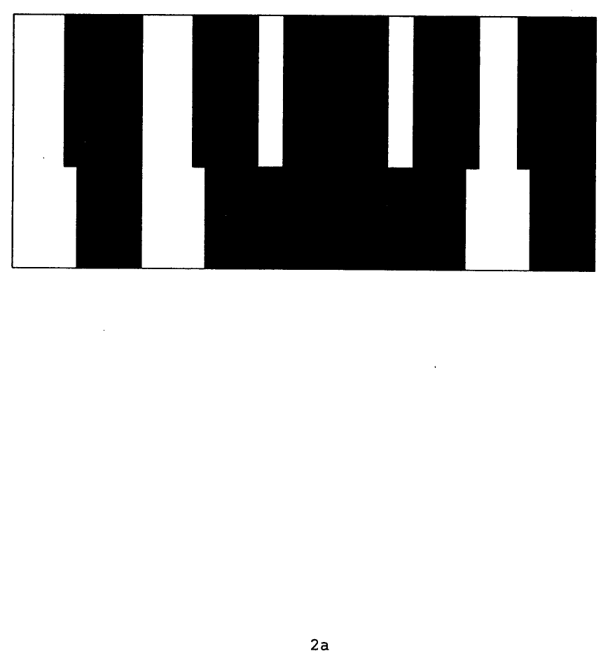

To illustrate this concept note that the basic structure of the Cubichord™ can be viewed at either FIG. 1-a, or for this example, that of FIGS. 2a & b, or 3a & b.¹⁰ Begin on a piano with the first key on a piano, A, colored a shaded grey in 1-a, or silver in FIG. 3a, under the Cubichord™ system. The next note, A#/Bb, is still traditional black.¹¹ But the Cubichord™ system then denotes the next key, B, gold, as demonstrated in the third segment but showing a white shade for gold in FIG. 1-a, and visibly evident in color in FIG. 3a.¹² Counting, then, 1,2,3, 1=silver, 2=black, and three=gold, this pattern of recoding or re-coloring a piano or keyboard should continue for the entire piano's keyboard. Like Lawrence Welk used to say: “123, 123, 123, 123”. This idea is the bare essence of Cubichord™, as the repeating pattern of three colors constructs Cubichord or Cubitar, and illustrates chord tones and all levels of inversions instantly, with only a shift in the tonic tone.
⁹There has been inadequate time and research to check this out empirically, but logic tells me what's good for the goose is good for the gander, and I've enjoyed great success from the keyboard to the Guitar, or Cubitar.

¹⁰ I prefer the drawings at 2a-c & 3a-c, as color is the essence of this system, and have filed an Application to Accept Color Drawings with this petition.

¹¹ Four notes remain the same color, but eight of the 12 will change colors under the Cubichord™ system.

¹² Note: the Black and White Drawings have been printed from the color version, and hence the silver shows grey on them, and the gold shows white. These may not copy properly, as both silver and grey will copy to white, destroying the three color system.

So, to continue up the scale, C, of course the note just to the left of the two traditionally black keys clustered in the upper deck set and to the right of the gold B, is again grey in FIG. 1-a, and again silver in FIG. 3a; C#/Db remains black, but D changes again to gold in this color scheme.¹³ Each separate color functions, as it develops, to isolate minor thirds. Whereas this set is also the set of diminished chords, which traditionally have been and are still used as the basic building blocks of a major, minor, and of all chord structures, these chord structures, or any interval, can now be visibly seen in full color for the first time by my reckoning, on Cubichord modified keyboards as well as modified stringed instruments, and most likely on all other instruments, and in future Cubichord™ and Cubitar™ charts.
¹³ The diminished chords under the Cubichord,™ system are these: Ab/G#, B, D, & F, the blue tones; A, C, Eb/D# & Gb/F# are the white tones, and Bb/A#, Db/C#, E & G are the black tones. Divide, categorize, and conquer!

To accomplish this modification, painting, taping, or manufactured colored strips that stick to a keyboard have been used, and have been tested on my models, and at the moment are under investigation and subject to further time and use testing. But, as it is also my dream and the objective of Cubichord™ to soon have instruments licensed by Cubichord to be manufactured in this useful and functional manner with a learning and improvisation booklet, only time will tell the best method of modification. Certainly, initial manufacture of instruments with this idea applied is an ultimate objective. Then, of course following the full studies and testing requirements for such a dramatic change, many more people should be playing their own instruments, and those who do play will play them with more range and greater variety in sounds.

To continue the system, the next note, D, belongs in the gold colored class, as do all notes of this diminished set of chord tones, similarly classified or colored, under the Cubichord™ system; a full diminished seventh chord, four notes, results in each colored class, silver, black and gold. To continue, the next note up, D#/Eb, is re-colored in the sequentially tight scheme, grey/silver; then E is repainted black, and F is then a gold key. F#/Gb is repainted from the traditional but musically meaningless black, to a meaningful, functional grey/silver, to include it in this set of diminished seventh chords. See footnote 10, supra.

G is similarly repainted black to affix this note into its minor third/diminished chord category, and the next and last note here under consideration, G#/Ab similarly re-colored gold. [See FIG. 1a and 3-a] This represents the full octave and the system then repeats itself up the scale. Now, revealed for the first time on a piano keyboard, Cubichord presents the visual illustration of the essential patterned building blocks of the major/minor scales, the diminished seventh chord. [See FIG. 1-a and 2a; note the newly displayed patterns here of two grey/silver keys down, A and C, and the two grey/silver keys up, Eb and Gb; next note the identical pattern of the two black keys up, Bb and Db, and the two black keys down, E & G; the next black key, Bb is a re-peat of the same pattern, as would show on a full keyboard; and finally the gold keys pattern is then three down, B, D, and F, with the last gold, Ab, in the upper deck of notes, the old traditionally raised black keys.] These three patterns are the essence of the system and similarly repeat on a guitar, though there is a different set of patterns there on which to focus. There is probably a near infinite number of color combinations to insert here; this instrument may just be your practice or learning instrument, or Cubichord may develop, it is hoped, into a major instrument for improvisation, recording, and performances.

It is just three of these notes in the Cubichord™ system, colored alike, that will provide the visual building blocks for the major triads, major dominant seventh chords, and similarly the minor triads and minor seventh chords. One simple adjustment from any foundational chord will then show the augmented chords, the Major seventh chords, and the suspended chords. [Flatten the 3^{rd} for a minor chord, with Cubichord™ it's a return to the Tonic color, silver in C; hold the fourth with the fifth for a suspended, or with Cubichord™ include the off tone, gold, in C; for the augmented chord, sharpen the fifth, or with Cubichord™ include the off tone above the fifth, below the sixth. [I find the use of the Designation Tonic color, Chord tone color, and Off tone color, most helpful in this respect, as it boils most decisions down to a choice between the three colors in most cases.]

This system not only visually presents an essential, basic, and continually used element of Music Theory, but for the first time organizes them so the learning of one chord provides a similar basis for learning that chord in all keys, visibly and simultaneously on the keyboard or stringed instrument. There are songs, then, that Cubichord™ can play with the simple use of two colors, like Brubeck's “Take Five” and Ellington's “Caravan”!

This system, it is hoped, should expand the repertoire of the beginning, average, and even advanced musician. Most musicians now play in one similar key, usually C, D, G or F; Cubichord™ will aid musicians to be able to expand their range of comfort and understanding to provide a fuller and more complete performance, potentially using all the keys and of all the notes.¹⁴ As varieties in voicing provide a fuller, richer sound, musical enjoyment and understanding increase, and hopefully, more people should be able to play instruments, once Cubichord™ has full Patent Protection, and the education and exposure to the system can be widely disseminated. What a joy!
¹⁴ This was a part of Schoenberg's vision, and has been the focus of Cubichord's vision™, too.

Furthermore, as these basic chords can then be simply modified to form the major sevenths and suspended chords, and those are all founded upon the basic chord structures, the building blocks for flattened 9ths, #11ths, and 13ths, etc. on up should be better and more fully understood, played, and listened to by all. When more people can play instruments, and play them better, the joys from these expectations may well indeed bring more peace and harmony to the world.

It is the recommendation of Cubichord™ that the rest of the keyboard/piano should be similarly re-colored, painted, or marked identically and sequentially with a Cubichord™ sequential color. This is done through the Cubichord™ system by simply alternating white, black and blue up the keyboard for the blue system, or silver, black and gold for the gold system, etc. Similarly, for a guitar, or Cubitar™, down the frets, up the scale chromatically, from the initial, open notes of E, A, D, G, B, E. [See FIG. 1-b and 3-b for the guitar; a violin has but four strings with open, set notes at E, A, D, and G.] Thus, the colors go across black, silver, gold, black, gold, black, for the top row, for those notes, respectively. The Cubichord™ system then progresses up the chromatic scale, for E: E, F, Gb, G, Ab, A, Bb, B, C, Db, D, Eb, E, etc., down each column beginning from the note at each open string, black, gold, and silver.

It is similarly the hope of Cubichord™ that this re-coloring, structural and functional system can be transferred to most any musical instrument.¹⁵ My preliminary research and investigation shows that it will work on a guitar/cubitar and should also function on most, if not all stringed instruments. And in testing the Cubichord™ on my own personal keyboard, I have not noticed that I am left unreasonably dependant on the visual prompts to find chords and chord tones. As Ray Charles and Stevie Wonder have proved, once it's “in the fingers” you've got it! I can play in the dark now.
¹⁵ It hasn't yet to date been tried on a Trumpet or a Trombone; the Trombone may in fact be so modified, but I am not sure, but hopeful, for the Trumpet.

Not that it wouldn't be nice to see the world full of these novel instruments manufactured with the Cubichord™ features and sanctioned licenses in mind. That will, of course, depend on marketing and the licensing agreements, market strategies and consumer responses, as well as the results of studies of the Cubichord™ concepts and application results. It is Cubichord's™ sincere hope and desire to either set up a Musical Foundation to do these things, or secure the assistance of an existing Foundation to do so, and therefore the urgent need to secure licensing agreements with instrument, keyboard, string and other manufacturers. Hence, this second step, following the Provisional Patent Application, the Real Patent Application.

Guitar Chords

To continue: any fretted instrument will also chart and illustrate visibly the notes, through an understanding of the diminished chord, major and minor chord system.¹⁶ This will be done for strings, just as with the keyboard, using either the same, or any choice of three colors, so long as the three colors accelerate up or down the chromatic scale sequentially, with no interruption, in the manner of Cubichord's™ exclusive colored system.¹⁷ This system has dynamic ramifications for all instrumentalists, beginning, intermediate or accomplished jazz improvisers. Just modify, either with permanent or temporary re-coloring on the instruments actual neck, per FIG. 3b, and the chords for any key will be revealed to you, on your instrument, with just a little study and focus, plus the added bonus of finding any note, once you have the Cubichord™ Gestalt in your mind.
¹⁶ Note: Cubichord has just this week discovered that the diagonal patterns on a guitar are in fact the Tritones, as from C-Gb/F#. Just knowing this will further help to “anchor” the musician in his instrument.

¹⁷ Cubichord is experimenting with Brown, Black and Red on the Guitar, and it looks great.

For the guitar I took the Cubichord™ system and literally applied it to first the E string, black, then down the neck and up the scale for all the frets, and in the same manner to the others, A, first white, D, again first Blue, as above, then to G, black, and to B, again blue, and exactly as before to the higher, bottom string, E, and obtained a strikingly simple chart, which can be applied to the neck in any three colors.¹⁸ [See FIG. 2-b and 3-b, showing the full color, unique patterns of notes and chords, a guitar has, in either blue or gold, with potential for any colors in this tri-colored scheme.] Then, once you understand the Cubichord™ system, which will be explained in my book, soon to be Copyrighted, and which Cubichord™ intends to call “The Black Forest”, the mysteries of music should unfold for those who have been traditionally daunted by long hours of practice and tied to musical notation for years before developing any serious joy from the use of their instrument.
¹⁸ now have applied Cubichord to a Guitar for Cubitar, and am learning with it where the notes are.

Notice how the results of the patterns on a guitar, as seen on the accompanying guitar chart in FIGS. 1-b, 2-b and 3b, yield remarkable diagonal patterns for the location of notes; these, research has developed, are the Tritones.¹⁹ Then, notice how these patterns have the potential and actually do show chords, right on the instrument, just as with a keyboard or piano.²⁰ Another very simple chord will be found in column four, three rows down. The A chord straight across has the same white and black patterns as the keyboard, with the E, fifth to the left, and the third, C#, to the right. These patterns have demonstrated to Cubichord™ in its research how remarkably simple it will now be to find any note on any similarly modified stringed or other instrument, such as a guitar or violin, especially once the piano or keyboard has been mastered. I call the guitar chart the “Gestalt Guitar Chart”, pending authorization to use the Gestalt name, but the Italian name for woman, Cubitar, is a fortuitous renaming of the Guitar I love.
¹⁹ See FN 13, supra.

²⁰ There are a variety of patterns, ranging from the horizontal D,G,B, anchoring G at the third string up, fourth column down, to the simple patterns that begin with D F-Bb, for the Bass Bb chord. It's all there, as these patterns or gestalts are the same for every note or tone, from every different string's perspective. The forks that show up to find chord tones lead you to play guitar/cubitar properly.

For example, find the C fret on the guitar chart at FIG. 2-b; as the nearest bass C is located under the Cubichord™ system, just above A, C is located as the white note on the second column or fifth guitar string, according to the Cubichord™ system, and traditional guitar theory. [Note how another, higher C is also located one note up from B in the second string or fifth column over from left to right; this high tone C is usually played with just one fret down, and the G on the third string in the fourth column over and E on the first string are played in what is called the open position.]

But the more difficult C is easily found as the next white note up the scale/down the neck from A. Then, there are the notes of the C major scale, the black note in the first, E column: G, the fifth for the C major scale, is the fret next to C; and so the third, as is the third for all chords, is in the third column, the first black tone there, is that strings E, the third for the C major scale. As a minor chord is but a flattened or lowered third, Eb, the C minor chord is then easily located by moving up the third column, fourth string [the strings are traditionally counted, I believe, 1,2,3,4,5,6, right to left; but as I count the columns across the rows E=1, A=2, D=3,G=4,B=5 and E=6, there is some confusion; the Cubichord™ color system may simplify and clarify this confusion.] But, since the Cubichord™ system is uniquely integrated and symmetrical, and logic so dictates in such a perfect system, this will similarly work to locate any chord, any tone, or any interval, on a stringed instrument. The learning of any chord structure on any string will easily transfer to the learning of all the chords for all the keys always, in all colors. The underlying knowledge of the patterns provides the boost hitherto unknown or unseen visually, so far as my research has shown, by the Music world.

Indeed, the distinct patterns of the three colors sets forth a remarkable pattern on a piano or keyboard, and will soon dramatically simplify and shorten learning time for both the novice, and for players stuck in C, F, and G, but not aware of how all the twelve keys or notes are chorded or stacked on their axe.²¹ Since designing Cubitar in March of this year I am now cognizant that to play from E to it's first chord tone, G#/Ab, the gold tone at FIG. 3b is next followed by the gold tone in the adjacent A open string, and you slip in a sixth, C# or Db/ with the flattened seventh or next chord tone at B, and you have the arpegiated dominant seventh chord, a foundational chord or melody for most modern and historical music. It's right there, visually.
²¹ Ax is the musicians slang for what he does with his chops, which is select and play chords; the analogy relates, I believe, to chord wood, and the difficulty of selecting or chopping these chords.

Piano Chords

The result of re-coloring an instrument using the Cubichord™ system is that the most common building block for major chords or minor chords is then instantly visibly displayed; that is the diminished chords are there, all colored white, black, or blue or if you choose, silver, black and gold, any three colors, but you have to then stick to them. These sequences, when combined with major thirds yield major and minor chords. The suspended chords and Major sevenths, can be found by sharpening the flattened seventh to the leading tone, and are now able to be visually represented on an instrument.

This is so because of the recurrence at each fourth note, or traditionally each fourth semitone or step up or down the scale, of an identical color. As explained, the Musical Theory explanation for this is that each set of colors represents a diminished seventh chord. As there are but three discrete sets of these chords, the marking with a color under the Cubichord™ system provides for ease at identification and location in a glance. The relationship between a major and minor third is illustrated by these colors.

The first illustration for a piano or keyboard should begin with the most common note, C, the fourth note in FIG. 2a, between the first blue or hatched note, B. As the next note up from C is Db/C#, and is colored black under the Cubichord™ system, tradition and harmonics mandates for now that it just sets the color under the Cubichord™ system for the Chord Tones for C as black. But knowing the black colored keys above are chord tones, there they are, C's third, E, the first chord tone; C's second chord tone, G, C's conmmonly called fifth, is the next black note up; similarly, for the dominant seventh, the next black note, Bb, is right there in a block of three. White+Black, then, equals a major chord, in sequence, a major triad, C, E, and G, and a dominant seventh, with the C#/Db as the commonly referred to flattened 9^{th}, when included with all four of the black diminished chords. Similarly, Black+Gold for the black tonics, and Gold+Silver for the Gold tones. Simple as that, you can construct any chord in any key, with this one principle, and with the Cubichord scheme.

As all chords are similarly structured, it is the hope of Cubichord™ that chords and random notes and difficult intervals now will be easier to see and learn; to see and to find in the hurry of playing a song for all levels of players. Again, given the symmetry and repeat of this identical pattern, this simple principle will work similarly in all keys, identically in all colors under the Cubichord™ system. An actual demonstration with a Cubichord™ model will reveal this simplicity.

Let us illustrate again: for the piano and keyboard with the white notes, A, C, Eb, and Gb=F7b9. In Cubichord's™ studies and research it has found that a difficulty exists when attempting to find the proper key to locate a major chord. But, as traditional Western Music has developed practice prescriptions that usually recommend selecting identifying and playing Major Chords from combining minor thirds from the sheet music notation system and then back to the instrument, with just rote practice of same, when expanding and experimenting with all twelve tones, practitioners soon became lost again in the Black Forest and fell down the Slippery Slope of one of the obscurities of music. So might the reader be lost now, but Cubichord™ can and will soon change that. Just color a keyboard or piano with this scheme and watch your learning curve go way up.

With a Cubichord™ system in place, Cubichord™ has discovered that by simply locating the color for the chord tones from a major scale relating to these notes, a major chord can easily be found with the colored keyboard by simply advancing up one color from any note, the Tonic, and selecting that color as the cord tone color. Alternatively, to invert a chord a player just backs up one full step from any given note, for example from Ab, which has identified chord tones of white, to the next three white tones below, and there is the Ab7, the Ab dominant seventh chord in its first inversion, beginning with the white tones C, Eb, Gb and to Ab.²²
²² The construction of a major or minor scale being identical interval measurements for each key, a similar analysis and application of the Cubichord™ system results.

Since this Ab7 is such a common and widely used chord, as are all dominant sevenths, they are written with the note and the seven as above, because they have tended to be the most used chords for a variety of pivotal functions in Traditional Western Music, not germane to this discussion except in their commonality of use. But also the most common chord, a simple triad, is also right there under the Cubichord™ system. See how the first two white notes in FIG. 2a combine with the next blue tone, F, to form the F Major chord, the first three, F7. [Blue is followed by white, up the scale, as is white preceded by blue, down the scale] above. Take three whites from C, and with the next tone above, there is the Major dominant seventh for a rarely used and commonly difficult chord, Ab7.

To simplify, when you combine the three white notes, C, Eb, Gb, with the blue of Ab, there is the Ab7 or the “A flat dominant seventh” chord. Another simple and facile example would be for the reader to take the first three white notes and select them, A, C, Eb; simply advance up one full tone, from Eb to F, and there is the F7 chord in its first inversion, F7/A. This is easily done, once one understands the Cubichord™ system, and will be readily demonstrated when one has a Cubichord™ Model to work with from FIG. 2a.

Thus, any two colors will form any major chord, as well as the minor chords. [See FIG. 1-c, et al]²³ As Cubichord has yet practiced and studied these effects on but a small number of tunes, harmonies and melodies, it becomes easier and easier to visually and simply invert chords [traditionally somewhat advanced and difficult] to the 1^{st}, 2^{nd}, and 3^{rd} inversions, placing the bass tonic tone atop or as the highest, or in the middle of these inversions. This result of rapidly and instantly re-voicing a lick is a common method of adding variety to a simple piece of music, and is what makes a simple performance more interesting and complex, while anchoring in any one key.²⁴ This, in my experience with Cubichord, is the greatest advance from Cubichord after locating simple chords, that they can be inverted in all the voicings with this system, simply and easily.
²³ When I began this discovery I was working on Duke Ellington's tune, “Caravan”; I could play it in C only; once I had my Cubichord™ designed and began to experiment, I could instantly play the tune anywhere on the Chromatic scale, just at a glance, and keeping the anchoring principles in mind. It was phenomenal!

²⁴ Yet my analysis shows application from Franz Liszt's diminished chord exercises to Beethoven's Fur Elise, and most remarkably to Dave Brubeck's “Take Five”, and most remarkably, to Duke Ellington's Caravan.

Similarly, visually viewing a keyboard or piano colored in the Cubichord™ scheme will demonstrate not only the essential phenomenon of the diminished chords, measured in minor thirds, but without repetitive counting, learning by rote, or years of study, but just by looking at the colors to get an orientation. The most commonly used chord tones in major or minor chords are minor thirds, and now they can be visible, right there in front of experienced and novice musicians alike, visible and laid out and ready to play for even a novice.

For a jazz improviser or classical musician, they are now also right there on his instrument, if not in his mind and memory, in one simple color! Because a major chord is just a major third followed by the two diminished thirds, [an interval under this scheme, from white to the second black above, and then for all the chord tones, the following set of diminished chords, as above] the simple triad will now be visibly apparent in all keys on a system colored with the Cubichord™ system. Similarly, because a minor chord is just the opposite, a minor third plus a major third, the same two color combination works, an any one key at a time, and simultaneously, for all twelve other major keys, as well as for all twelve other minor keys as well. It's like black and white have finally found color, blue, gold, green or red, all work in sets of three!

Lets illustrate again with another colored note, Bb, the second note in FIG. 2a.²⁵ Since the next color for the Bb note a semitone up is blue in FIG. 2a you simply skip this note, but mentally mark the colors for the chord tones blue. Then using the blue as the marker for the chord tones, you find D, the second blue note above Bb, or Bb's “third”, the first chord tone; similarly, the next blue tone up is F, and there it is, the next blue tone up; likewise the flattened seventh Ab is there for Bb, the third blue tone above the omitted blue tone, Ab. An accomplished musician will also make use of the first tone, B, as it is, yes, the flattened ninth, for a Bb7b9 chord, all in two colors. These are all the notes for a single section in Ellington's Caravan, and in Brubeck's Take Five, as well in a great majority of all songs. None, of course, uses more than the three colors, ever, as the entire scale is covered by these three colors' distribution.
²⁵ Note: although one proof for one chord is all that is logically required to prove the claim for all tones, I continue to show how this works with all colors to remove all doubt.

The same also applies with the first blue tone, B. Skip the first marker/chord note, C, which marks the chord tones white, and Cubichord shows you where they are: the next three are chord tones, white notes now for the blue, and there's D# , the third for B, F#, B's fifth, and A, B's flattened 7^{th}, all white and neatly laid out for inversions. This phenomenon, Cubichord™ believes, has really simplified music, because it also works perfectly in every other note, and as will be shown below, to find minor chords too. A minor chord will simply flatten the third, or first chord tone, but Cubichord's research shows they are still represented by only two colors, in all the keys.²⁶
²⁶ It is most interesting that a major scale holds 3 of the four off tones, and in a harmonic minor, all 4 of the diminished set are present.

While many of the added bonuses of this system are yet to be discovered, one additional bonus became instantly obvious to me when I applied the concept of the Cubichord™ system to the musical phenomenon known as the circle of fourths or the circle of fifths.²⁷ The same notes that had been re-colored Cubichord™ style alternated in both directions, clockwise or also in a counterclockwise manner, white, black to blue, clockwise, and white, blue to black, counterclockwise. This relates to the history of my discovery, as I had been wrestling for months with the interface of the major and minor thirds, and had developed the chart which is at the foundation of why this principle works in a simple and universal manner:

| | | |
|---|---|---|
| Ab | C | E |
| B | Eb | G |
| D | Gb | Bb |
| F | A | Db |

Moving horizontally to the right from any point, and then vertically down/up to any will yield the same result. For example, Ab-C, Eb, Gb, A, gives a Major dominant seventh chord with the flattened 9^{th}, a very useful jazz and general all purpose chord, which includes the common major triad, diminished triads and sevenths chords, the Ab7b9. It is my formation of this very chart which eventually resulted in Cubichord. I came up with the colors over the columns.
²⁷ Fourths are counted counterclockwise around the circle, fifths are counted in a clockwise manner.

Similarly, as a lot of jazz and classical music relies on the alternating tensions between the fourths and fifths, as anchored with the tonic, these three colors blossom forth to reveal and illustrate this musical theory conception. For example, typical blues in C usually involves just the basic C, F, C, G, C progressions. [White, Blue, White, Black, White, or Tonic, off color, Tonic, off color, Chord tone, Tonic]. Set the tone with the Tonic, first note, white, and strike a contrast with what I designate an “off tone”, in this case blue [the note below], and then to the tonic to the contrast, off tone, and then to the dominant seventh, black, utilizing the chords tones of the particular tonic note, C.

That's generally all there is to the basic structure of the blues, baby, and to a lot of traditional classical and rock music too. Before the Cubichord™ system, there was nothing to illustrate these principles but a lot of rote practice or rare genius. Now, with Cubichord it is all there on your instrument, visible to see, or to feel in brail, right before your eyes and/or fingers, and could even be in Red, White, and Blue, for the Patriot in you, or in any three colors of your choice, in the Cubichord™ system.

### SUMMARY

So, to sum up: whereas traditional music theory and education has apparently overlooked the simplifying structure of a three color system, and has used just numbers to refer to Tonic, Third, Fourths and Fifths, to the flattened seventh, Cubichord unifies these sets for easy visual recognition with its unique coloring system, and still supports the traditional numbering system, merely enhancing it with colors.

²⁸ The visual illustration of the diminished chords also reveals the full 12 notes or tones in the chromatic scale, and each of their dominant seventh flattened ninth tones [7b9]; this shows the player at any given moment generally what not to play or what to play. Just knowing at a particular moment that only black and white fits here, or white and blue fits there, or black and blue fits at this moment in the song, generally solves this problem. With the Cubichord system on an instrument, anyone can bolster his playing skills and vary the tired old vanilla sounds to include chocolate, to the immense variety provided when you add the blue notes, or to more easily play in the range of keys from F to Gb, and many more may be able to learn and love the music they now play on their own instrument.²⁹
²⁸here are seven notes in a Major and Minor scale; eight in the be-bob scale, and the mystery still remains, which seven or eight are relevant to the particular scale; the coloration system in the Cubichord™ boils it down to three, and in my experience, any of the colors will usually provide the guide to any particular lick or exercise, from Beethoven's Fur Elise, to Brubeck's Take Five!

²⁹ Only more experience and research will reveal these, for in some song structures these “dissonances” will be sought for further resolution.

### CONCLUSION

It is my sincere hope and desire that the entire field of Musicians and the general population will hereafter enjoy a new phase in development and performance of musical instruments, once the three color concept of the Cubichord™ has been entered into the stream of Interstate and International Commerce. The personal application of the three color concept to illustrate the basic structure of good sounds should bring more people the immense joy and satisfaction of playing music that I have found since entering Music's Black Forrest and defining the main trails with Cubichord; it is my belief and dream that Music may yet soothe the savage beast in us all, and my sincere hope that the Cubichord™ will have assisted in this phenomenon.

Cubichord visually measures musical note intervals and chord structures in a system that is easy to understand and visually obvious directly on the instrument, whether piano, guitar, or any instrument with the system applied. In conjunction with this, Cubichord envisions a related application to musical notation, coloring according to a preferred or selected system, similar to the system applied on the instrument used. Since Cubichord works on the Cubitar model, which applies the Cubichord system to the Guitar or Cubitar, this is just another application of this one claim for chord/interval measurement. The three claims are:

1. Musical instrument manufacturer using the Cubichord System.

2. Musical education, training, performance and recording using the Cubichord System

3. Musical notation and publication using the Cubichord System.
